(19) United States
(12) Patent Application Publication
(10) Pub. No.: US 2024/0274333 A1
(43) Pub. Date: Aug. 15, 2024

(54) LOW-COST HIGH-COERCIVITY LACE-RICH NEODYMIUM-IRON-BORON PERMANENT MAGNET, AND PREPARATION METHOD THEREFOR AND USE THEREOF

(71) Applicants: YANTAI ZHENGHAI MAGNETIC MATERIAL CO., LTD., Yantai, Shandong (CN); NANTONG ZHENGHAI MAGNET CO., LTD., Rugao City, Nantong, Jiangsu (CN)

(72) Inventors: Bingqiang SHI, Yantai, Shandong (CN); Zhongxin AN, Yantai, Shandong (CN); Chubo DENG, Yantai, Shandong (CN); Lei LIU, Yantai, Shandong (CN); Yanmei JIN, Yantai, Shandong (CN)

(21) Appl. No.: 18/568,831

(22) PCT Filed: Jun. 13, 2022
(86) PCT No.: PCT/CN2022/098425

§ 371 Date: Dec. 10, 2023

(30) Foreign Application Priority Data
Jun. 11, 2021 (CN) 202110656406.5

(51) Int. Cl. H01F 1/057; B22F 3/16; B22F 3/24; B22F 9/02; B22F 9/04; C22C 33/02; C22C 35/00; C22C 38/00; C22C 38/06; C22C 38/14; C22C 38/16; H01F 41/02

(52) U.S. Cl. CPC H01F 1/0577; B22F 3/16; B22F 3/24; B22F 9/023; B22F 9/04; C22C 33/0207; C22C 33/0278; C22C 35/005; C22C 38/002; C22C 38/005; C22C 38/06; C22C 38/14; C22C 38/16; H01F 41/0266; H01F 41/0293; B22F 2003/248; B22F 2009/044; B22F 2201/20; B22F 2202/05; B22F 2301/355; B22F 2304/10; B22F 2998/10; B22F 2999/00; C22C 2202/02

(57) ABSTRACT

A low-cost high-coercivity LaCe-rich neodymium-iron-boron permanent magnet, and a preparation method therefor and the use thereof are provided. The permanent magnet is prepared by mixing and sintering an LaCe-free and HRE-free neodymium-iron-boron main phase alloy and an LaCe-M alloy. An LaCe-free main phase alloy and an LaCe-M auxiliary phase alloy are respectively smelted at first, and then, the same are subjected to powder preparation, mixing, pressing, and sintering, thereby avoiding LaCe entering main phase crystal grains. The depth and concentration of HRE diffused into the magnet are effectively improved by using the characteristics of a low melting point and high flowability of an LaCe-rich crystal boundary phase, thereby improving the uniformity of components and structure distribution in the magnet.

The present application claims priority to the Patent Application No. 202110656406.5, entitled “LOW-COST HIGH-COERCIVITY LACE-RICH NEODYMIUM-IRON-BORON PERMANENT MAGNET, AND PREPARATION METHOD THEREFOR AND USE THEREOF”, filed with the China National Intellectual Property Administration on Jun. 11, 2021, which is incorporated herein by reference in its entirety.

### TECHNICAL FIELD

The present disclosure belongs to the field of rare earth permanent magnets, and particularly relates to a low-cost high-coercivity LaCe-rich neodymium-iron-boron permanent magnet, a preparation method therefor and use thereof.

### BACKGROUND

Sintered neodymium-iron-boron, as the third generation rare earth permanent magnet material, mainly consists of elements such as rare earth PrNd, iron, boron, and the like, and is widely applied to the fields of various rare earth permanent magnet motors, intelligent consumer electronic products, medical devices, and the like due to its excellent magnetic properties and high cost performance. With the rapid development of low-carbon, environment-friendly, economical, and high-new technologies, the demand for sintered neodymium-iron-boron magnets is increasing day by day, which greatly drives the consumption of rare earth PrNd resources, so that the price of PrNd is gradually increased. La and Ce, as rare earth elements with chemical properties similar to PrNd and with the most abundant reserves, have limitations of use in the field of rare earth permanent magnet materials due to their relatively low intrinsic magnetic properties.

La and Ce in Bayan Obo mine of China account for above 70% of the total rare earths. However, due to limited market demands for La and Ce and their coexistence with Pr, Nd, Dy and Tb in rare earth ores, excessive mining has caused overstock, thus leading to a market situation of oversupply.

Therefore, La and Ce are adopted to replace Pr and Nd in the application of neodymium-iron-boron sintering, which can not only reduce the costs of starting materials, but also facilitate the balanced utilization of rare earth resources. However, the saturation magnetic polarization strength and the magnetocrystalline anisotropy field of La₂Fe₁₄B and Ce₂Fe₁₄B are lower than those of R—Fe—B, so that use of La and Ce instead of Pr and Nd will inevitably cause the deterioration of magnetic properties of the magnet.

In the prior art, there are mainly the following approaches to add La and Ce into magnets: the first approach is to add them through alloying, that is, to add starting materials of metal La and Ce in the smelting process; the second is to add them through dual alloying, that is, to prepare (R, LaCe)—Fe—B and R—Fe—B alloy scales (R is selected from one or more of Nd, Pr, Dy, Tb, Ho, and Gd) by smelting, and then press and sinter the alloy scales described above after mixing them in a certain ratio; the third is to attach a compound or an alloy of La and Ce on the surface of the magnet and perform an appropriate heat treatment process to diffuse La and Ce into the interior of the magnet.

In the approaches described above, the addition in an alloying process will cause La and Ce to enter main phase grains, so that the properties of the main phase grains, such as saturation magnetic polarization strength, Curie temperature, and magnetocrystalline anisotropy field, can be reduced, thereby reducing the initial properties of the magnet, and further limiting the application and development of the magnet. However, adding La and Ce into the interior of the magnet through diffusion has technical defects, such as the complicated process, insufficient addition amounts of La and Ce, and difficulty in enhancing the coercivity of the magnet, so the cost performance is low, which is not conducive to the application and development of the magnet. The addition in an dual alloying process can prevent La and Ce from entering the main phase grains to some extent, and thus, this method has gradually become a mainstream preparation process of neodymium-iron-boron magnets containing La and Ce.

However, in order to achieve the preparation of a high-performance neodymium-iron-boron magnet containing La and Ce and make up for the reduction in magnetic properties caused by the addition of La and Ce, a certain amount of heavy rare earth elements such as Dy and Tb is usually added to improve the magnetic properties of the magnet when preparing the magnet rich in La and Ce. The method described above not only greatly increases the manufacturing costs of the magnet, but also exacerbates the crisis of heavy rare earth resources, and therefore is not conducive to the sustainable utilization of rare earth resources. Therefore, how to prepare a high-performance neodymium-iron-boron magnet rich in La and Ce to reduce the production cost of the magnet and facilitate the sustainable utilization of rare earth resources becomes a technical problem to be solved urgently.

### SUMMARY

In order to solve the technical problem described above, the present disclosure provides a neodymium-iron-boron permanent magnet, which consists of the following components in percentage by mass: Re₀+Re₁+Re₂: 24.2-38 wt. %, Al: 0.1-1.5 wt. %, Ga: 0.1-1 wt. %, B: 0.9-1 wt. %, and the balance of a transition state metal element;

wherein:

the Re₀ element is selected from one or two of La and Ce, preferably two of La and Ce; preferably, the Re₀ can be 0.1-9 wt. % based on the total mass of the magnet;

the Re₁ element is selected from one or two of Pr and Nd and comprises at least Nd; preferably, the Re₁ can be 24-28 wt. % based on the total mass of the magnet;

the Re₂ element is selected from at least one of Dy, Tb, and Ho; preferably, the Re₂ can be 0.1-1 wt. % based on the total mass of the magnet.

Preferably, the transition metal element comprises at least Fe and Co elements. For example, the transition element is selected from Co, Cu, Zr, Ti, and Fe.

Preferably, the transition metal element comprises the following components in percentage by mass: Co: 0.1-3 wt. %, Cu: 0.1-1.5 wt. %, Zr: 0-1 wt. %, Ti: 0.1-2 wt. %, and the balance of Fe.

According to an exemplary embodiment of the present disclosure, the neodymium-iron-boron permanent magnet consists of the following components in percentage by mass: Re₀: 0.1-9 wt. %, Re₁: 24-28 wt. %, Re₂: 0.1-1 wt. %; Co: 0.1-3 wt. %, Al: 0.1-1.5 wt. %, Cu: 0.1-1 wt. %, Ga: 0.1-1 wt. %, Zr: 0-1 wt. %, Ti: 0.1-2 wt. %, B: 0.9-1 wt. %, and the balance of Fe.

According to an embodiment of the present disclosure, the neodymium-iron-boron permanent magnet has a following microstructure characteristic: consisting of a main phase, a grain boundary phase, and a composite phase between the main phase and the grain boundary phase.

Preferably, the main phase comprises grains with an average crystal grain size of 2-7 m, illustratively 2 m, 3 m, 4 m, 5 m, 6 m, or 7 m.

Preferably, grains of the main phase comprise a Re₁ element, but does not comprise Re₀ and Re₂ elements, and grains of the main phase have an R₂T₁₄B type phase structure, wherein T represents a transition metal element, and T comprises at least Fe and Co elements.

Preferably, the grain boundary phase is continuously distributed in a straight stripe shape along the boundary of the grains of the main phase.

Preferably, the grain boundary phase comprises at least Re₀, Re₁ and Re₂ elements, and one or more of Co, Al, Cu, Ga, Zr, Ti, B, and Fe elements.

Preferably, the composite phase is present between the main phase and the grain boundary phase.

Preferably, the neodymium-iron-boron permanent magnet has a microstructure substantially as shown in FIG. 1.

Preferably, the composite phase comprises Re₀, Re₁, and Re₂ elements, and has an R₂T₁₄B type phase structure, wherein T represents transition metal elements, and T comprises at least Fe and Co.

According to an embodiment of the present disclosure, the permanent magnet is prepared by mixing and powder preparation of a LaCe-free and HRE-free neodymium-iron-boron main phase alloy and a LaCe-M alloy, followed by pressing and vacuum sintering; wherein: HRE refers to a heavy rare earth element, e.g., at least one selected from Dy, Tb and Ho, and M represents at least one of Al, Cu and Fe.

According to an embodiment of the present disclosure, an anti-oxidation lubricant can be optionally added in the preparation process of the permanent magnet. Preferably, the anti-oxidation lubricant can be used in an amount of 0.01-2 wt. %, illustratively 0.01 wt. %, 0.05 wt. %, 0.1 wt. %, 0.5 wt. %, 1 wt. %, or 2 wt. %, based on the total weight of the powder.

The present disclosure also provides a preparation method for the neodymium-iron-boron permanent magnet described above, which comprises mixing starting materials of a LaCe-free and HRE-free neodymium-iron-boron main phase alloy and a LaCe-M alloy, and performing vacuum liquid-phase sintering to prepare a neodymium-iron-boron permanent magnet rich in La and Ce.

According to an embodiment of the present disclosure, the LaCe-free and HRE-free neodymium-iron-boron main phase alloy and the LaCe-M alloy are defined and selected as described above.

Since there will be impurities of La, Ce or HRE in smelting and metallurgy processes of rare earth metals, those skilled in the art can understand that when La is less than 0.1 wt. %, Ce is less than 0.1 wt. %, and HRE is less than 0.1 wt. % in the neodymium-iron-boron main phase alloy, the alloy is regarded as the LaCe-free and HRE-free neodymium-iron-boron main phase alloy.

According to an embodiment of the present disclosure, the LaCe-free and HRE-free neodymium-iron-boron main phase alloy is an alloy scale. Preferably, the alloy scale has a thickness of 0.1-0.4 mm, illustratively 0.1 mm, 0.2 mm, 0.3 mm, or 0.4 mm.

According to an embodiment of the present disclosure, the LaCe-free and HRE-free neodymium-iron-boron main phase alloy is prepared by vacuum smelting and casting of starting materials comprising a Re₁ source, a transition metal source, a Ga source, an Al source, and a B source.

Preferably, the Re₁ source is provided by a simple substance (pure metal) or an alloy comprising a Re₁ element, preferably provided by an alloy comprising a Re₁ element, such as a PrNd alloy.

Preferably, the transition metal source, the Ga source, and the Al source are provided by a simple substance or an alloy comprising a transition metal element, a Ga element, and an Al element, and are preferably provided by a simple substance comprising a transition metal element, a Ga element, and an Al element.

Preferably, the B source is provided by a compound comprising a B element, such as B—Fe sand.

According to an embodiment of the present disclosure, the auxiliary phase alloy is an alloy scale.

Preferably, the alloy scale has a thickness of 0.1-0.4 mm, illustratively 0.1 mm, 0.2 mm, 0.25 mm, 0.3 mm, or 0.4 mm.

According to an embodiment of the present disclosure, the auxiliary phase alloy is prepared by vacuum smelting and casting of starting materials comprising a Re₀ source and a M source.

Preferably, the Re₀ source and the M source are provided by a simple substance (pure metal) or an alloy comprising a Re₀ element and a M element, and preferably provided by a simple substance comprising a Re₀ element and a M element.

Preferably, the smelting is performed under an inert atmosphere, for example, under a nitrogen or an argon atmosphere, preferably under an argon atmosphere.

Preferably, the main phase alloy and the auxiliary phase alloy have identical or different casting temperatures in the smelting process. For example, the casting temperatures can be independently 1300-1500° C., illustratively 1300° C., 1400° C., or 1500° C.

Preferably, the main phase alloy and the auxiliary phase alloy have identical or different casting processes. For example, the casting processes can be independently casting the molten liquid onto a rotating water-cooled copper roller. Further, the rotating water-cooled copper roller has a rotation speed of 15-45 rpm, illustratively 15 rpm, 20 rpm, 25 rpm, 30 rpm, 40 rpm, or 45 rpm.

According to an embodiment of the present disclosure, the smelting of the main phase alloy and/or the auxiliary phase alloy is performed in a vacuum induction furnace.

According to an embodiment of the present disclosure, before the vacuum liquid-phase sintering, the method further comprises mixing the main phase alloy and the auxiliary phase alloy.

Preferably, the main phase alloy and the auxiliary phase alloy can be separately subjected to hydrogen decrepitation, dehydrogenation, and jet milling to prepare a main phase alloy powder and an auxiliary phase alloy powder.

Preferably, the main phase alloy and the auxiliary phase alloy can be mixed in the form of smelting scales or at any stage of hydrogen decrepitation, dehydrogenation, or jet milling.

Preferably, the main phase alloy powder has an average particle size of 3-6 m, illustratively 3 m, 4 m, 5 m, or 6 m.

Preferably, the auxiliary phase alloy powder has an average particle size of 1-3 m, illustratively 1 m, 2 m, or 3 m.

According to an embodiment of the present disclosure, the preparation method further comprises mixing the main phase alloy powder and the auxiliary phase alloy powder, and then performing press molding.

Preferably, in the permanent magnet, the main phase alloy powder is in percentage by mass of 75-99.5 wt. %, e.g., 85-95 wt. %; the auxiliary phase alloy powder is in percentage by mass of 0.5-25 wt. %, e.g., 5-15 wt. %.

According to an embodiment of the present disclosure, the mixing described above is performed under stirring.

According to an embodiment of the present disclosure, the press molding comprises orientated press molding and isostatic press molding. Preferably, the orientated press molding is performed firstly to obtain a compact, and then the isostatic press molding is performed to prepare a compact, so as to further increase the density of the compact. Further, the orientated pressing is performed in a magnetic field, and the isostatic press molding is performed in an isostatic press.

Preferably, the mixed powder is subjected to orientated press molding under an inert atmosphere, for example, under nitrogen or argon atmosphere, preferably under nitrogen atmosphere.

Preferably, the orientation magnetic field has a magnetic field strength of 2-5 T, illustratively 2 T, 3 T, 4 T, or 5 T.

Preferably, the isostatic press molding is performed under a pressure of 150-260 MPa, illustratively 150 MPa, 180 MPa, 200 MPa, 220 MPa, 240 MPa, or 260 MPa.

Preferably, the compact has a density of 4-6 g/cm³, illustratively 4 g/cm³, 4.6 g/cm³, 5 g/cm³, or 6 g/cm³.

According to an embodiment of the present disclosure, the vacuum liquid-phase sintering is performed by two calcinations to prepare the LaCe-rich HRE-free neodymium-iron-boron permanent magnet.

Preferably, the calcinations are performed at identical or different temperatures, e.g., 900-1100° C., preferably 950-1100° C., illustratively 900° C., 950° C., 1000° C., 1015° C., 1030° C., or 1100° C. For example, the calcinations are performed for identical or different periods of time, e.g., 4-8 h, preferably 4-6 h, illustratively 4 h, 5 h, 6 h, or 8 h.

Preferably, the calcinations are both at a heating rate of 5-15° C./min, illustratively 5° C./min, 8° C./min, 10° C./min, 12° C./min, or 15° C./min.

Preferably, the first sintering treatment of the vacuum liquid-phase sintering is performed at a vacuum degree of no more than 1×10⁻² Pa.

Preferably, the second sintering treatment of the vacuum liquid-phase sintering is performed under an inert atmosphere, for example, under nitrogen or argon atmosphere, preferably under argon atmosphere.

According to an embodiment of the present disclosure, after the first sintering treatment of the vacuum liquid-phase sintering is finished, Ar gas is charged and the system is cooled to no more than 100° C.

Preferably, the cooling rate is >20° C./min, illustratively 20° C./min, 25° C./min, 30° C./min, or 40° C./min.

According to an embodiment of the present disclosure, the preparation method further comprises cooling the LaCe-rich HRE-free magnet obtained after the vacuum liquid-phase sintering to no more than 65° C.

According to an embodiment of the present disclosure, the preparation method further comprises subjecting the LaCe-rich HRE-free magnet obtained after the vacuum liquid-phase sintering to an aging treatment to prepare the low-HRE neodymium-iron-boron permanent magnet rich in La and Ce.

Preferably, the aging treatment is performed by a two-stage calcination treatment, wherein a first-stage calcination is performed at a temperature of 800-1000° C., illustratively 800° C., 900° C., or 1000° C.; a first-stage calcination is performed for 0.5-36 h, illustratively 0.5 h, 1 h, 2 h, 5 h, 12 h, 15 h, 20 h, 24 h, 30h, or 36h.

A second-stage calcination is performed at a temperature of 400-600° C., preferably 450-550° C., illustratively 400° C., 450° C., 500° C., 510° C., 550° C., or 600° C.; a second-stage calcination is performed for 1-6 h, preferably 2-5 h, illustratively 1 h, 2 h, 3 h, 4 h, 5 h, or 6 h.

Preferably, after the first-stage calcination treatment, the reaction product is cooled to no more than 80° C., e.g., 70° C., 60° C., 50° C., 40° C., 30° C., or room temperature.

Preferably, the diffusion source of the aging treatment is a diffusion source comprising a Re₂ element, wherein: the Re₂ element is at least one of Dy, Tb, and Ho. Further, the diffusion source comprising the Re₂ element is a pure metal, an alloy, or a compound comprising the Re₂ element, preferably a compound comprising the Re₂ element, illustratively a fluorine compound comprising Re₂.

Preferably, the aging treatment is performed as follows: adhering a diffusion source comprising a Re₂ element to the surface of the magnet, and performing an aging treatment in a vacuum heat treatment furnace to prepare the low-HRE neodymium-iron-boron magnet rich in La and Ce.

For example, the diffusion source may be deposited and attached on the surface of the magnet by coating, dipping, magnetron sputtering, spray coating, etc., preferably by spray coating.

According to an embodiment of the present disclosure, the preparation method for the neodymium-iron-boron permanent magnet comprises the following steps:
step 1, weighing and proportioning a Re₁ source, a transition metal source, a Ga source, an Al source, and a B source based on the weight percentage according to component design requirements, smelting the mixture by using a vacuum induction furnace under Ar atmosphere, and casting the molten liquid after the smelting onto a rotating water-cooled copper roller to prepare a main phase alloy scale;
step 2, weighing and proportioning starting materials of a Re₀ source and a M source according to component design requirements, smelting the mixture by using a vacuum induction smelting furnace under Ar atmosphere, and casting the molten liquid after the smelting onto a rotating water-cooled copper roller to prepare an auxiliary phase alloy scale;
step 3, separately subjecting the main phase alloy scale and the auxiliary phase alloy scale to hydrogen decrepitation, dehydrogenation, and jet milling to prepare a main phase alloy powder and an auxiliary phase alloy powder;
step 4, mixing the main phase alloy powder and the auxiliary phase alloy powder, performing orientated pressing in a magnetic field to obtain a compact, and pressing the compact by using an isostatic press to further increase the density of the compact;
step 5, sintering the compact in a vacuum sintering furnace to prepare a LaCe-rich HRE-free magnet; and
step 6, adhering a diffusion source comprising a Re₂ element to the surface of the magnet, and performing an aging treatment in a vacuum heat treatment furnace to prepare the low-HRE neodymium-iron-boron magnet rich in La and Ce.

The present disclosure also provides use of the neodymium-iron-boron permanent magnet described above in the fields of rare earth permanent magnet motors, intelligent consumer electronics products, medical devices, and the like.

### Advantageous Effects of Present Disclosure:

(1) According to the present disclosure, the LaCe-free main phase alloy and the LaCe-M auxiliary phase alloy are separately smelted at first, and then subjected to powder preparation, mixing, pressing, and sintering, so that the performance defect that the magnet properties are reduced due to LaCe entering the main phase grain is effectively avoided, and the manufacturing cost of the magnet is reduced, thereby achieving the balance and sustainable utilization of rare earth resources.
(2) According to the present disclosure, by utilizing the excellent characteristics of low melting point, high flowability, and wettability of the LaCe-rich grain boundary phase, the depth and concentration of HRE diffusing into the magnet are effectively increased, which is beneficial to improving the uniformity of components and tissue distribution in the magnet.
(3) According to the present disclosure, the LaCe-rich neodymium-iron-boron is subjected to diffusion treatment, so that the preparation of the low-HRE high-coercivity LaCe-rich neodymium-iron-boron permanent magnet is achieved, the amount of HRE used is effectively reduced, and the balanced utilization and sustainable development of rare earth resources are promoted.
(4) According to the preparation method for the HRE-free neodymium-iron-boron permanent magnet rich in La and Ce of the present disclosure, the magnet is prepared by mixing LaCe-M and a LaCe-free neodymium-iron-boron alloy scale, or separately performing powder preparation, followed by mixing, pressing, and sintering, so that the amount of PrNd used in the neodymium-iron-boron magnet is reduced, the uniform distribution of a rare earth-rich phase in the magnet is facilitated, and the deterioration of magnetic parameters such as magnetocrystalline anisotropy of main phase grains and saturation magnetic polarization strength caused by the fact that La and Ce enter the main phase grains due to alloying is avoided, which is beneficial to the enhancement of the magnetic properties of the magnet. The La and Ce are enriched in the grain boundary, so that the melting point and the sintering temperature of the grain boundary phase are reduced, and the flowability and the continuity of the grain boundary phase are improved, thereby being beneficial to the distribution of the rare earth-rich phase along the grain boundary to form a continuous and smooth grain boundary phase (as shown in FIG. 1), which inhibits the nucleation of an anti-magnetization domain, effectively isolates the magnetic exchange coupling effect between main phase grains, and thus enables the neodymium-iron-boron permanent magnet rich in La and Ce to have higher magnetic properties.
(5) In the preparation process of the low-HRE neodymium-iron-boron permanent magnet rich in La and Ce of the present disclosure, the La and Ce are intensively distributed in the grain boundary phase (as shown in FIGS. 2-4), so that the wettability and the flowability of the grain boundary phase are improved, thereby increasing the depth and the concentration of HRE diffusing into the core of the magnet, which is conducive to the formation of a composite phase with a high magnetocrystalline anisotropy field between the main phase grain and the grain boundary phase in the magnet, and to the improvement of anti-magnetization domain nucleation field on the surface of the main phase grain, thus significantly enhancing the coercivity of the magnet. In addition, the composite phase microstructure with consistent components and structures, which is formed between the main phase grains and the grain boundary phase in the whole magnet, enables the magnet to uniformly form the anti-magnetization domain during anti-magnetization, thereby significantly improving the squareness of the magnet.

### BRIEF DESCRIPTION OF THE DRAWINGS

FIG. 1 is a scanning electron microscope image showing a grain boundary phase, a composite phase, and a main phases in a magnet.

FIG. 2 is an SEM image showing the distribution of a grain boundary phase and a main phase in the magnet.

FIG. 3 is an EPMA image showing the distribution of a La element in the magnet.

FIG. 4 is an EPMA image showing the distribution of a Ce element in the magnet.

### DETAILED DESCRIPTION

The embodiments of the present disclosure will be further illustrated in detail with reference to the following specific examples. It should be understood that the following examples are merely exemplary illustrations and explanations of the present disclosure, and should not be construed as limiting the protection scope of the present disclosure. All techniques implemented based on the content of the present disclosure described above are included within the protection scope of the present disclosure.

Unless otherwise stated, the starting materials and reagents used in the following examples are all commercially available products, or can be prepared using known methods.

In the following examples of the present disclosure, PrNd was added in the form of an alloy, the remaining metals were added in the form of simple substances, and B was provided by B—Fe sand.

### Example 1

(1) The components were proportioned according to component design requirements: PrNd: 29.2 wt. %, Co: 1 wt. %, Ga: 0.3 wt. %, Al: 0.1%, Cu: 0.1 wt. %, Zr: 0.2 wt. %, Ti: 0.2 wt. %, B: 1.04 wt. %, and the balance of Fe. Starting materials of a main phase alloy were weighed and smelted by using a vacuum induction smelting furnace under Ar atmosphere, and the molten liquid was casted onto a water-cooled copper roller at the rotation speed of 30 rpm, with the liquid casting temperature of 1400° C., so that main phase alloy scales with an average thickness of 0.3 mm were prepared.
(2) The components were proportioned according to component design requirements: La: 10 wt. %, Ce: 50 wt. %, Al: 5 wt. %, Cu: 5 wt. %, and the balance of Fe. Starting materials of an auxiliary phase alloy were smelted by using a vacuum induction smelting furnace under Ar atmosphere, and the molten liquid was casted onto a water-cooled copper roller at a rotation speed of 35 rpm, with the liquid casting temperature of 1400° C., so that auxiliary phase alloy scales with an average thickness of 0.25 mm were prepared.
(3) The main phase alloy scales and the auxiliary phase alloy scales were separately subjected to hydrogen decrepitation, dehydrogenation, and jet milling to prepare alloy powders with an average particle size of 4 m and 2 m, respectively. 95 wt. % of a main phase alloy powder and 5 wt. % of an auxiliary phase alloy powder were separately weighed and mixed under N2 atmosphere, followed by the addition of 0.05 wt. % of an anti-oxidation lubricant (conventional anti-oxidation lubricant known in the art), and then the mixture was stirred and mixed homogeneously.
(4) The mixed powder was filled into a die cavity of a die of a pressing device under N2 atmosphere, subjected to oriented press molding with an orientation magnetic field strength of 3 T, and then subjected to isostatic pressing treatment in an isostatic press under a pressure of 180 MPa to obtain a compact with a density of 4.6 g/cm³ (obtained by weighing and size measurement of the compact and then calculating).
(5) The compact was fed into a vacuum sintering furnace under N2 atmosphere and sintered with heat preservation at 1015° C. for 5 h, with the sintering vacuum degree of no more than 1×10⁻² Pa. After the heat preservation was finished, Ar gas was charged for cooling to no more than 80° C., and the compact was heated to 1030° C. and sintered with heat preservation for 6 h. Then Ar gas was charged for cooling to no more than 65° C., and the compact was taken out to obtain a sintered blank with a density of 7.55 g/cm³.
(6) After the sintered blank was subjected to mechanical processing and grinding treatment, dysprosium fluoride was adhered to the surface of the magnet by spray coating, and the magnet was weighed before and after the operation of dysprosium fluoride adhesion by spray coating to enable the coated dysprosium fluoride to be 0.6 wt. % based on the total weight of the magnet. Then, diffusion treatment was performed at 900° C.×20 h in a vacuum heat treatment furnace. Ar gas was charged for cooling to no more than 80° C., and the sintered blank was heated to 510° C. and subjected to an aging treatment with heat preservation for 5 h. Ar gas was charged for cooling to no more than 60° C., and the sintered blank was taken out to obtain a low-Dy neodymium-iron-boron permanent magnet rich in La and Ce.

### Example 2

Example 2 differed from Example 1 only in that: in the step (3), the mass percentage of the main phase alloy powder was 88 wt. %, and the mass percentage of the auxiliary phase alloy powder was 12 wt. %.

### Example 3

Example 3 differed from Example 1 only in that: in the step (6), after the surface of the sintered blank is treated, a pure metal film layer of Tb is adhered, and the magnet was weighed before and after the adhesion operation to control the Tb film layer to be 0.6 wt. % based on the total weight of the magnet.

### Example 4

Example 4 differed from Example 1 only in that: in the step (2), the auxiliary phase alloy comprises the following components in percentage by weight: Ce: 60 wt. %, Al: 5 wt. %, Cu: 5 wt. %, and the balance of Fe.

### Example 5

Example 5 differed from Example 1 only in that: in the step (1), the main phase alloy comprises the following components in percentage by weight: PrNd: 28 wt. %, Co: 2.5 wt. %, Ga: 0.3 wt. %, Al: 0.3%, Cu: 0.1 wt. %, Zr: 0.2 wt. %, Ti: 0.2 wt. %, B: 1 wt. %, and the balance of Fe.

### Comparative Example 1

Provided is a preparation method for the sintered neodymium-iron-boron permanent magnet, which comprises the following steps:
(1) The components were proportioned according to component design requirements: PrNd: 27.74 wt. %, La: 0.5 wt. %, Ce: 2.5 wt. %, Co: 0.95 wt. %, Al: 0.35 wt. %, Cu: 0.35 wt. %, Ga: 0.29 wt. %, Zr: 0.19 wt. %, Ti: 0.19 wt. %, B: 0.99 wt. %, and the balance of Fe. Starting materials were weighed and smelted by using a vacuum induction smelting furnace under Ar atmosphere, and the molten liquid was casted onto a water-cooled copper roller at the rotation speed of 30 rpm, with the liquid casting temperature of 1400° C., so that alloy scales with an average thickness of 0.3 mm were prepared.
(2) The alloy scales are subjected to hydrogen decrepitation, dehydrogenation, and jet milling to prepare an alloy powder with the granularity of 4 m, 0.05 wt % of anti-oxidation lubricant was added under N2 atmosphere, and the mixture was stirred and mixed homogenously.
(3) The alloy powder was filled into a die cavity of a die of a pressing device under N2 atmosphere, subjected to oriented press molding with an orientation magnetic field strength of 3 T, and then subjected to isostatic pressing treatment in an isostatic press under a pressure of 180 MPa to obtain a compact with a density of 4.6 g/cm³.
(4) The compact was fed into a vacuum sintering furnace under N2 atmosphere and sintered with heat preservation at 1015° C. for 5 h, with the sintering vacuum degree of no more than 1×10⁻² Pa. After the heat preservation was finished, Ar gas was charged for cooling to no more than 80° C., and the compact was heated to 1030° C. and sintered with heat preservation for 6 h. Then Ar gas was charged for cooling to no more than 65° C., and the compact was taken out to obtain a sintered blank with a density of 7.55 g/cm³.
(5) After the sintered blank was subjected to mechanical processing and grinding treatment, dysprosium fluoride was adhered to the surface of the magnet by spray coating, and the magnet was weighed before and after the operation of dysprosium fluoride adhesion by spray coating to enable the dysprosium fluoride to be 0.6 wt. % based on the total weight of the magnet. Then, diffusion treatment was performed at 900° C.×20 h in a vacuum heat treatment furnace. Ar gas was charged for cooling to no more than 80° C., and the compact was heated to 510° C. and subjected to an aging treatment with heat preservation for 5 h. Ar gas was charged for cooling to no more than 60° C., and the compact was taken out.

### Comparative Example 2

Except for other steps, Comparative Example 2 differed from Comparative Example 1 only in that: in the step (1), the components were proportioned according to component design requirements: PrNd: 27.74 wt. %, Co: 0.95 wt. %, Al: 0.1 wt. %, Cu: 0.1 wt. %, Ga: 0.29 wt. %, Zr: 0.19 wt. %, Ti: 0.19 wt. %, B: 0.99 wt. %, and the balance of Fe.

### Comparative Example 3

Except for other steps, Comparative Example 3 differed from Example 1 only in that: in the step (2), the auxiliary phase alloy comprises the following components in percentage by weight: Al: 5 wt. %, Cu: 5 wt. %, and the balance of Fe.

The magnetic properties of the magnets prepared in Examples 1-5 and Comparative Examples 1-3 described above were tested by using an NIM-62000 permanent magnet material precision measuring system. The results are shown in Table 1 below.

TABLE 1

| | Br (T) | Hcj (kA/m) | (BH)ₘₐₓ |
|---|---|---|---|
| Example 1 | 1.398 | 1811.3 | 383.0 |
| Example 2 | 1.33 | 2035 | 347.5 |
| Example 3 | 1.395 | 2131.8 | 385.4 |
| Example 4 | 1.379 | 1856.4 | 372.8 |
| Example 5 | 1.407 | 1800.6 | 387.9 |
| Comparative Example 1 | 1.353 | 1503.7 | 379.8 |
| Comparative Example 2 | 1.391 | 1697.3 | 384.7 |
| Comparative Example 3 | 1.394 | 1752.1 | 381.3 |

As can be seen by comparing the results of Examples 1-5 with the results of Comparative Example 1 in Table 1, the Hcj property of the magnet prepared in the present disclosure is better than that of the magnet prepared by adding LaCe in an alloy smelting process; as can be seen further comparing the results of Examples 1-5 with the results of Comparative Example 2, the addition of the auxiliary alloy of the present disclosure can soften the reduction in the Hcj magnetic property of the magnet due to the addition of LaCe; as can be seen by comparing the results of Examples 1-5 with the result of Comparative Example 3, by adding LaCe into the auxiliary phase alloy in the present disclosure, a low-cost high-coercivity LaCe-rich neodymium-iron-boron permanent magnet with excellent properties can be prepared.

The above examples illustrate the embodiments of the present disclosure. However, the present disclosure is not limited to the embodiments described above. Any modification, equivalent, improvement, and the like made without departing from the spirit and principle of the present disclosure shall fall within the protection scope of the present disclosure.

1. A neodymium-iron-boron permanent magnet, consisting of the following components in percentage by mass: Re₀+Re₁+Re₂: 24.2-38 wt. %, Al: 0.1-1.5 wt. %, Ga: 0.1-1 wt. %, B: 0.9-1 wt. %, and the balance of a transition metal element;
wherein:
the Re₀ element is selected from one or two of La and Ce, preferably two of La and Ce;
preferably, the Re₀ can be 0.1-9 wt. % based on the total mass of the magnet;
the Re₁ element is selected from one or two of Pr and Nd and comprises at least Nd; preferably, the Re₁ can be 24-28 wt. % based on the total mass of the magnet;
the Re₂ element is selected from at least one of Dy, Tb, and Ho; preferably, the Re₂ can be 0.1-1 wt. % based on the total mass of the magnet;
preferably, the transition metal element comprises at least Fe and Co elements; for example, the transition element is selected from Co, Cu, Zr, Ti, and Fe;
preferably, the transition metal element comprises the following components in percentage by mass: Co: 0.1-3 wt. %, Cu: 0.1-1.5 wt. %, Zr: 0-1 wt. %, Ti: 0.1-2 wt. %, and the balance of Fe.

2. The permanent magnet according to claim 1, consisting of the following components in percentage by mass: Re₀: 0.1-9 wt. %, Re₁: 24-28 wt. %, Re₂: 0.1-1 wt. %; Co: 0.1-3 wt. %, Al: 0.1-1.5 wt. %, Cu: 0.1-1 wt. %, Ga: 0.1-1 wt. %, Zr: 0-1 wt. %, Ti: 0.1-2 wt. %, B: 0.9-1 wt. %, and the balance of Fe.

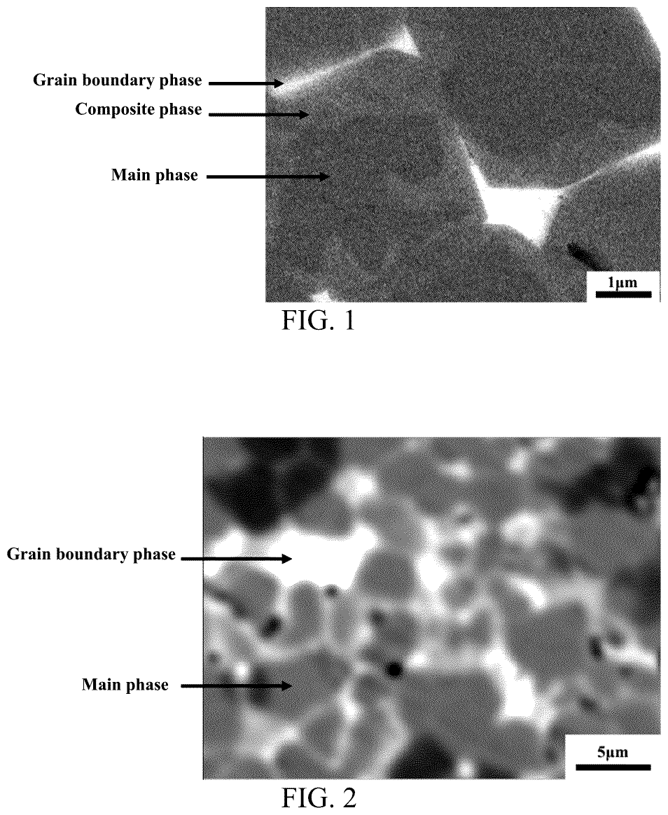

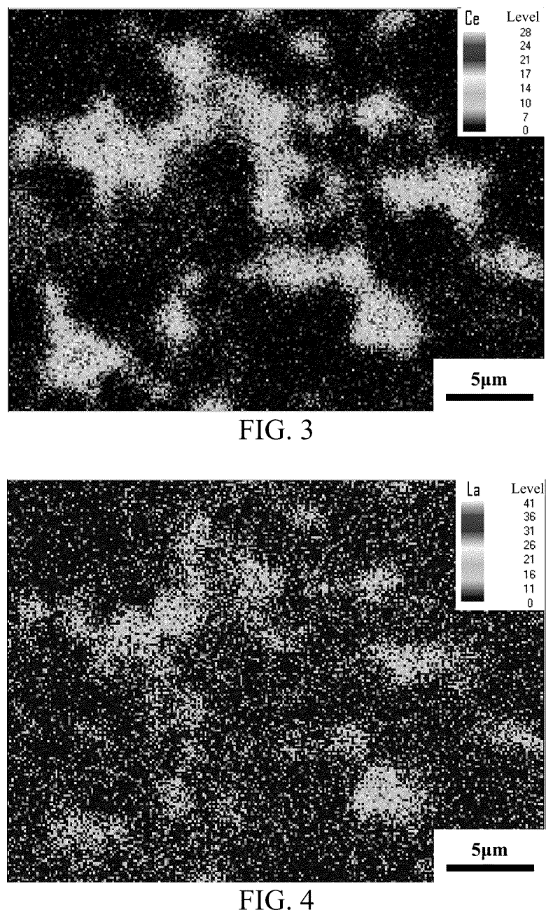

3. The permanent magnet according to claim 1, wherein the permanent magnet has a following microstructural characteristic: consisting of a main phase, a grain boundary phase, and a composite phase between the main phase and the grain boundary phase;
preferably, the main phase comprises grains with an average crystal grain size of 2-7 μm;
preferably, grains of the main phase comprise a Re₁ element, but does not comprise Re₀ and Re₂ elements, and grains of the main phase have an R₂T₁₄B type phase structure, wherein T represents a transition metal element, and T comprises at least Fe and Co elements;
preferably, the grain boundary phase is continuously distributed in a straight stripe shape along the boundary of the grains of the main phase;
preferably, the grain boundary phase comprises at least Re₀, Re₁ and Re₂ elements, and one or more of Co, Al, Cu, Ga, Zr, Ti, B, and Fe elements;
preferably, the composite phase is present between the main phase and the grain boundary phase;
preferably, the permanent magnet has a microstructure substantially as shown in FIG. 1;
preferably, the composite phase comprises Re₀, Re₁, and Re₂ elements, and has an R₂T₁₄B type phase structure, wherein T represents transition metal elements, and T comprises at least Fe and Co.

4. The permanent magnet according to claim 1,
wherein the permanent magnet is prepared by mixing and sintering of a LaCe-free and HRE-free neodymium-iron-boron main phase alloy and a LaCe-M alloy; wherein:
HRE refers to a heavy rare earth element, e.g., at least one selected from Dy, Tb and Ho, and M represents at least one of Al, Cu and Fe.

5. A preparation method for the permanent magnet according to claim 1, comprising mixing starting materials of a LaCe-free and HRE-free neodymium-iron-boron main phase alloy and a LaCe-M alloy, and performing vacuum sintering to obtain the neodymium-iron-boron permanent magnet rich in La and Ce; wherein preferably, the LaCe-free and HRE-free neodymium-iron-boron main phase alloy and the LaCe-M alloy are as defined and selected in claim 1;
preferably, the LaCe-free and HRE-free neodymium-iron-boron main phase alloy is an alloy scale; preferably, the alloy scale has a thickness of 0.1-0.4 mm.

6. The preparation method according to claim 5, wherein the LaCe-free and HRE-free neodymium-iron-boron main phase alloy is prepared by vacuum smelting and casting of starting materials comprising a Re₁ source, a transition metal source, a Ga source, an Al source, and a B source,
preferably, the Re₁ source is provided by a simple substance (pure metal) or an alloy comprising a Re₁ element, preferably provided by an alloy comprising a Re₁ element, such as a PrNd alloy;
preferably, the transition metal source, the Ga source, and the Al source are provided by a simple substance or an alloy comprising a transition metal element, a Ga element, and an Al element, and are preferably provided by a simple substance comprising a transition metal element, a Ga element, and an Al element;
preferably, the B source is provided by a compound containing a B element.

7. The preparation method according to claim 5, wherein the auxiliary phase alloy is an alloy scale, preferably, the alloy scale has a thickness of 0.1-0.4 mm;
preferably, the auxiliary phase alloy is prepared by vacuum smelting and casting of starting materials comprising a Re₀ source and a M source;
preferably, the smelting is performed under an inert atmosphere, for example, under a nitrogen or an argon atmosphere, preferably under an argon atmosphere;
preferably, the main phase alloy and the auxiliary phase alloy have identical or different casting temperatures in the smelting process; for example, the casting temperatures can be independently 1300-1500° C.;
preferably, the main phase alloy and the auxiliary phase alloy have identical or different casting processes; for example, the casting processes can be independently casting the molten liquid onto a rotating water-cooled copper roller; further, the rotating water-cooled copper roller has a rotation speed of 15-45 rpm;
preferably, the main phase alloy and the auxiliary phase alloy can be separately subjected to hydrogen decrepitation, dehydrogenation, and jet milling to prepare a main phase alloy powder and an auxiliary phase alloy powder;
preferably, the main phase alloy and the auxiliary phase alloy can be mixed in the form of smelting scales or at any stage of scale smelting, hydrogen decrepitation, dehydrogenation, and jet milling;
preferably, before the vacuum liquid-phase sintering, the preparation method further comprises performing hydrogen decrepitation, dehydrogenation, and jet milling on the main phase alloy and the auxiliary phase alloy to prepare a main phase alloy powder and an auxiliary phase alloy powder;
preferably, the main phase alloy powder has an average particle size of 3-6 μm;
preferably, the auxiliary phase alloy powder has an average particle size of 1-3 m.

8. The preparation method according to claim 5,
further comprising mixing the main phase alloy powder and the auxiliary phase alloy powder, and then performing press molding; wherein
preferably, in the permanent magnet, the main phase alloy powder is in percentage by mass of 75-99.5 wt. %, e.g., 85-95 wt. %; the auxiliary phase alloy powder is in percentage by mass of 0.5-25 wt. %, e.g., 5-15 wt. %;
preferably, the press molding comprises orientated press molding and isostatic press molding, and preferably, the orientated press molding is performed firstly to obtain a compact, and then the isostatic press molding is performed to prepare a compact, so as to further increase the density of the compact;
preferably, the orientation magnetic field has a magnetic field strength of 2-5 T;
preferably, the isostatic press molding is performed under a pressure of 150-260 MPa;
preferably, the vacuum liquid-phase sintering is performed by two calcinations to prepare a LaCe-rich HRE-free magnet;
preferably, the two calcinations are performed at identical or different temperatures, e.g., 900-1100° C., preferably 950-1100° C.;
preferably, the two calcinations are performed at identical or different temperatures, e.g., 4-8 h, preferably 4-6 h;
preferably, the two calcinations are both at a heating rate of 5-15° C./min;
preferably, the preparation method further comprises performing aging treatment on the LaCe-rich HRE-free magnet obtained after vacuum liquid-phase sintering to prepare a low-HRE neodymium-iron-boron magnet rich in La and Ce;
preferably, the aging treatment is performed by a two-stage calcination treatment, wherein a first-stage calcination is performed at a temperature of 800-1000° C., and a first-stage calcination is performed for 0.5-36 h;
a second-stage calcination is performed at a temperature of 400-600° C., preferably 450-550° C.; a second-stage calcination is performed for 1-6 h, preferably 2-5 h;
preferably, the diffusion source of the aging treatment is a diffusion source comprising a Re₂ element, wherein: the Re₂ element is at least one of Dy, Tb, and Ho;
preferably, the diffusion source comprising a Re₂ element is a pure metal, an alloy, or a compound comprising a Re₂ element;
preferably, the aging treatment is performed as follows: adhering a diffusion source comprising a Re₂ element to the surface of the magnet, and performing an aging treatment in a vacuum heat treatment furnace to prepare the low-HRE neodymium-iron-boron magnet rich in La and Ce.

9. The preparation method according to claim 5,
comprising the following steps:
step 1, weighing and proportioning a Re₁ source, a transition metal source, a Ga source, an Al source, and a B source based on the weight percentage according to component design requirements, smelting the mixture by using a vacuum induction furnace under Ar atmosphere, and casting the molten liquid after the smelting onto a rotating water-cooled copper roller to prepare a main phase alloy scale;
step 2, weighing and proportioning starting materials of a Re₀ source and a M source according to component design requirements, smelting the mixture by using a vacuum induction smelting furnace under Ar atmosphere, and casting the molten liquid after the smelting onto a rotating water-cooled copper roller to prepare an auxiliary phase alloy scale;
step 3, separately subjecting the main phase alloy scale and the auxiliary phase alloy scale to hydrogen decrepitation, dehydrogenation, and jet milling to prepare a main phase alloy powder and an auxiliary phase alloy powder;
step 4, mixing the main phase alloy powder and the auxiliary phase alloy powder, performing orientated pressing in a magnetic field to obtain a compact, and pressing the compact by using an isostatic press to further increase the density of the compact;
step 5, sintering the compact in a vacuum sintering furnace to prepare a LaCe-rich HRE-free magnet; and
step 6, adhering a diffusion source comprising a Re₂ element to the surface of the magnet, and performing an aging treatment in a vacuum heat treatment furnace to prepare the low-HRE neodymium-iron-boron magnet rich in La and Ce.

10. Use of the permanent magnet according to claim 1 in the fields of rare earth permanent magnet motors, intelligent consumer electronics, medical devices, and the like.
